(19) United States
(12) Patent Application Publication
(10) Pub. No.: US 2018/0211339 A1
(43) Pub. Date: Jul. 26, 2018

(54) SYSTEMS, METHODS, AND COMPUTER-READABLE MEDIA FOR GENERATING PROPERTY AND TENANT INSIGHTS BASED ON SENSOR DEVICES

(71) Applicant: Microsoft Technology Licensing, LLC, Redmond, WA (US)

(72) Inventors: David MOWATT, Dublin (IE); Terry FARRELL, Dublin (IE)

(73) Assignee: Microsoft Technology Licensing, LLC, Redmond, WA (US)

(21) Appl. No.: 15/414,812

(22) Filed: Jan. 25, 2017

(51) Int. Cl. G06Q 50/16; G06Q 30/02; G06Q 30/06; H04L 29/08; G08G 1/065

(52) U.S. Cl. CPC G06Q 50/163; G06Q 30/0201; G08G 1/065; H04L 67/12; G06Q 30/0645

(57) ABSTRACT

Systems, methods, and computer-readable media are disclosed for generating property and tenant insights based on sensor devices. One method includes: receiving a plurality of attributes of a plurality of tenants that have rented at least one property of a plurality of properties; receiving a plurality of attributes of the plurality of properties; receiving sensor data of at least one sensor monitoring the property; analyzing, for each property, the sensor data of the at least one sensor monitoring the property to convert the sensor data into aggregated sensor data; associating, for each property, the aggregated sensor data with the tenant renting the property and the property; and generating, for each property and each tenant, a plurality of insights based on one or more of the aggregated sensor data, the plurality of attributes of a plurality of tenants, and the plurality of attributes of the plurality of properties.

### TECHNICAL FIELD

Embodiments of the present disclosure relate generally to the field of e-commerce. More specifically, embodiments of the present disclosure relate to generating property and tenant insights based on sensor devices, such as Internet of Things (“IoT”) devices.

### INTRODUCTION

Trends in connectivity and in Internet of Things (“IoT”) devices are resulting in dramatic changes in people's lives. For example, the IoT devices now allows individuals access to vast amounts of data, as well as the ability to interact and share the data with individuals, organizations, and companies around the world. This has resulted in a significant increase in the use of the data in online transactions, which is sometimes referred to as “e-commerce.” Additionally, the increasingly powerful computing and communication capabilities of IoT devices, as well as the growing set of data being produced has led to the accelerated use of the data in other applications and a variety of different tasks.

IoT devices may allow for real property automation and monitoring. For example a property owners or tenant may control and access a property's lighting, security, heating, air conditioning, energy, etc. from any connected device. The use of the IoT devices may enable more intelligent functions, like turning off the lights and lowering the heat when a room has been vacated.

Although many properties may include IoT devices, a common networked system that ties these IoT devices to property owner, landlords, current tenants, and potential tenants does not exist. Thus, there exists a need to provide a system that connects tenants, properties, and IoT devices in the properties to effectively share information to improve the use of different properties.

### SUMMARY OF THE DISCLOSURE

According to certain embodiments, systems, methods, and computer-readable media are disclosed for generating property and tenant insights based on sensor devices.

According to certain embodiments, computer-implemented methods for generating property and tenant insights based on sensor devices are disclosed. One method includes: receiving, at a server over an electronic communications network, a plurality of attributes of a plurality of tenants that have rented at least one property of a plurality of properties; receiving, at the server over the electronic communications network, a plurality of attributes of the plurality of properties; receiving, at the server over the electronic communications network from each property of the plurality of properties, sensor data of at least one sensor monitoring the property; analyzing, by the server for each property, the sensor data of the at least one sensor monitoring the property to convert the sensor data into aggregated sensor data; associating, by the server for each property, the aggregated sensor data with the tenant renting the property and the property; and generating, by the server for each property and each tenant, a plurality of insights based on one or more of the aggregated sensor data, the plurality of attributes of a plurality of tenants, and the plurality of attributes of the plurality of properties.

According to certain embodiments, systems for generating property and tenant insights based on sensor devices are disclosed. One system including: a data storage device that stores instructions for generating property and tenant insights based on sensor devices; and a processor configured to execute the instructions to perform a method including: receiving, over an electronic communications network, a plurality of attributes of a plurality of tenants that have rented at least one property of a plurality of properties; receiving, over the electronic communications network, a plurality of attributes of the plurality of properties; receiving, over the electronic communications network from each property of the plurality of properties, sensor data of at least one sensor monitoring the property; analyzing, for each property, the sensor data of the at least one sensor monitoring the property to convert the sensor data into aggregated sensor data; associating, for each property, the aggregated sensor data with the tenant renting the property and the property; and generating, for each property and each tenant, a plurality of insights based on one or more of the aggregated sensor data, the plurality of attributes of a plurality of tenants, and the plurality of attributes of the plurality of properties.

According to certain embodiments, non-transitory computer-readable media are disclosed that store instructions that, when executed by a computer, cause the computer to perform a method for generating property and tenant insights based on sensor devices. One method of the computer-readable media including: receiving, over an electronic communications network, a plurality of attributes of a plurality of tenants that have rented at least one property of a plurality of properties; receiving, over the electronic communications network, a plurality of attributes of the plurality of properties; receiving, over the electronic communications network from each property of the plurality of properties, sensor data of at least one sensor monitoring the property; analyzing, for each property, the sensor data of the at least one sensor monitoring the property to convert the sensor data into aggregated sensor data; associating, for each property, the aggregated sensor data with the tenant renting the property and the property; and generating, for each property and each tenant, a plurality of insights based on one or more of the aggregated sensor data, the plurality of attributes of a plurality of tenants, and the plurality of attributes of the plurality of properties.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 depicts an exemplary environment for generating property and tenant insights based on sensor devices, such as Internet of Things (“IoT”) devices, according to embodiments of the present disclosure;

FIG. 2 depicts a flowchart illustrating a method for generating property and tenant insights based on sensor devices, according to embodiments of the present disclosure;

FIG. 3 depicts another flowchart illustrating a method for generating property and tenant insights based on sensor devices, according to embodiments of the present disclosure; and

FIG. 4 is a simplified functional block diagram of a computer that may be configured as a device for executing the methods of FIGS. 2 and 3, according to exemplary embodiments of the present disclosure.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF THE EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having,” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.”

For the sake of brevity, conventional techniques related to systems and servers used to conduct online auctions and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

The present disclosure relates to generating property and tenant insights based on sensor devices, such as Internet of Things (“IoT”) devices. For example, IoT devices may allow for the networking of physical devices, also referred to as “connected devices” and “smart devices,” embedded with electronics, software, sensors, actuators, network connectivity, etc., which enable these IoT devices to collect and exchange data. The collection and exchange of data from these IoT devices may allow for a system to learn about behaviors and preferences of users interacting with the IoT devices. Further, the system may also gain and/or generate insights about the users (“tenants”) of a property in which the IoT devices reside, and gain and/or generate insights about the property in which the IoT devices reside.

This tenant data and property data generated from the IoT devices may be provided to a centralized system and/or a distributed system. As explained in detail below, the centralized system and/or distributed system may use the tenant data and property data to generate more intelligent recommendations (“insights”), such as other properties, tenants, and IoT devices that may benefit a user of the system. For example, a tenant renting a property may have IoT devices located in and/or on the property, which may learn about the tenant living at the property. The data generated from the IoT devices may be provided to the system, which may generate a set of personalized recommendations for the next property that the tenant may wish to rent. In another example, a property rental agency may use the system to determine which tenants may be a best fit for a property based on data generated by the previous tenants, which may increase the average tenancy of rental properties.

As mentioned above, the system may use data from IoT devices in and/or on a property to determine suitability of a property to potential tenants. The system may also improve the ability for a tenant to find more suitable properties and for landlords and/or property owners to find tenants who are more likely to stay in the property for a longer term. The system may be suitable for residential, commercial, and/or industrial properties, such as, for example, rental of office space and/or small business space.

While the system may require some level of IoT devices in a property to gain insights about the tenants of the property, the system may make recommendations for properties without IoT devices to the tenants. For example, from the data of the IoT devices and/or insights generated from the data, the system may provide a tenant with better matches for properties based on the tenant's cooking needs, the tenant's space needs, the tenant's desired noise levels (e.g., low noise, such as from the absence of small children and/or instrument playing), and/or the tenant's generated noise levels (e.g., from small children and/or instrument playing). Further, from the data of the IoT devices and/or insights generated from the data, the system may provide landlords and/or property owners with better property/tenant matches based on, for example, tenants that keep the property clean and/or generate little to no noise. Further, the system may allow landlords and/or properties owners to provide evidence to potential tenants that a property has reasonable heating costs, temperature control, humidity control, does not have excessive background noise (such as from roads and/or neighbors), etc.

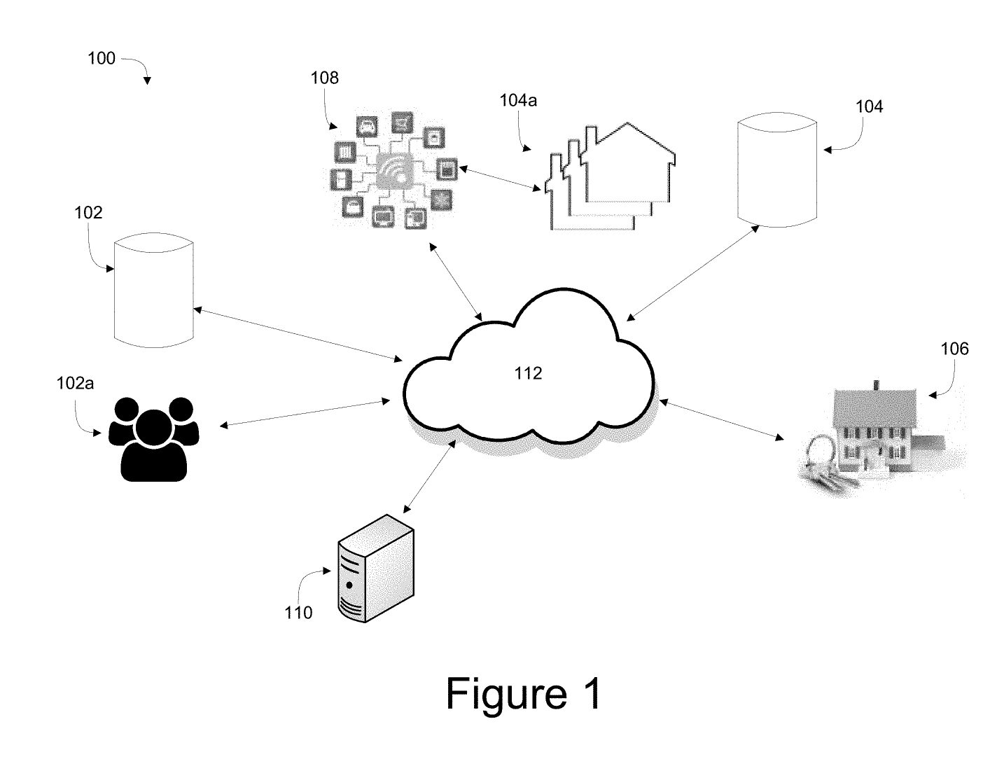

FIG. 1 depicts an exemplary environment for generating property and tenant insights based on sensor devices, such as Internet of Things (“IoT”) devices, according to embodiments of the present disclosure. The environment 100 may include a tenant database 102, which includes one or more attributes about one or more tenants 102a who have rented one or more properties 104a. For example, the tenant database 102 may include a distribution of the tenants 102a of a particular property (e.g., two (2) parents, a teenager boy, a toddler girl, a dog). The one or more attributes stored in the tenant database 102 may include access restrictions to that restrict access to only a property agency 106 that has rented to the tenants 102a. For commercial and/or industrial properties, the one or more attributes about the one or more tenants 102a may include a type of business and/or a number of employees. Further, the tenant database 102 may store an association about which tenants 102a rented which one or more properties 104a, and a period of the rental of the property in association with the tenants. In some embodiments of the present disclosure, the one or more attributes of a tenant 102a stored the tenant database 102 may include an online identity, such as a social network account, of each tenant 102a.

As shown in FIG. 1, the environment 100 may also include a properties database 104, which includes one or more attributes about one or more properties 104a to be rented. The one or more attributes may include one or more of a rental agency 106 (if applicable), a property owners, and a base set of attributes, such as a number of rooms, a number of bedrooms, whether the property is a detached property, terrace, condominium, etc., a yard size, closet space, attic space, garage space, parking spaces/type, storage space, etc. For commercial and/or industrial properties, the base set of attributes may include storage space, shelf space, a number of cash registers, a size of windows, a type of property, such as an indoor mall vs. strip-mall, etc.

Each property of the one or more properties 104a may also include one or more sensors 108 residing in and/or on the property. For example, there may be one or more sensors 108 to detect when a vehicle is parked in the parking space or garage, one or more sensors 108 to detect when the property 104a is occupied, one or more sensors 108 to detect noise levels in the property 104a or around the property 104a, one or more temperature sensors 108, one or more humidity sensors 108 in various rooms of the property 104a. Further, there may be one or more sensors 108 attached to a vacuum cleaner and/or to cleaning supplies in a closet of the property 104a, one or more sensors 108 to detect whether a closet shelf is full, one or more sensors 108 to detect when a kitchen closet or bedroom closet door is opened, etc. A heating system of the property 104a may also provide sensor data (so that heating usage may be monitored). Key devices of the property 104a, such as cooking appliances, televisions, computers, shower, toilet, sinks, etc. may also provide sensor data. For a commercial property, one or more sensors 108 may count shoppers, such as via a camera on a roof and/or on a ceiling of the property 104a, a length of a line at cash registers, a number of meeting rooms available, a number of people sitting in a meeting room, etc.

In certain embodiments of the present disclosure, some sensors 108 may be more accurate than other sensors. For example, a motion detection sensor may indicate that someone was in the house, or the motion detection sensor may be advanced enough to know that two (2) parents and two (2) children were in particular rooms at particular times, or that a given room was occupied at a given hour of a given day. In some embodiments of the present disclosure, one or more sensors 108 may include recording sounds that are used to determine whether a given noise is human speech/shouting, music, animals, traffic, etc. Further, additional sensors may be used to determine whether the noise is a television, a sound system, etc. The sensors 108 may also record decibel level to be used to determine how loud a noise is/was.

Sensor data from the one or more sensors 108 may be provided to a server 110. The server 110 may be located at the property 104a and/or may be remote from the property 104a. When the server 110 is remote from the property 104a, the sensor data from the one or more sensors 108 may be transmitted to the server 110 via an electronic communications network 112, such as the Internet, and intranet, a local area network, a wide area network, etc. The server 110 may also be in electronic communication with the tenant database 102 and the property database 104 via the electronic communications network 112. The server 110 may be configured to receive, from the tenant database, a plurality of attributes of a plurality of tenants that have rented at least one property of a plurality of properties. Additionally, the server 110 may be configured to receive, from the property database, a plurality of attributes of the plurality of properties.

The sensor data generated by the one or more sensors 108 may be stored by the server 110 in one or both of a raw format and/or an aggregated and averaged format. Raw format sensor data may be all of the sensor data recorded by the one or more sensors 108, and aggregated and averaged format sensor data may be processed sensor data that averages and/or aggregates sensor data over a predetermined period of time. For example, aggregated and averaged format sensor data may include, on a given day across all bed rooms of a property 104a, that closets were 86% full. Further, aggregated and averaged format sensor data may include, on a given morning in the living areas of a property 104a, that a temperature was 56 degrees and humidity was 4%.

In one embodiment of the present disclosure, the server 110 may analyze, for each property of the plurality of properties, the sensor data associated with the property to convert the sensor data into aggregated/averaged sensor data. Then, the server 110 may associate either or both of the sensor data and/or aggregated/averaged sensor data with the property and the tenants resided in the property.

Upon receiving a sufficient amount of sensor data from sensors 108 and/or converting a sufficient amount of aggregated/averaged sensor data, insight about the property and/or one or more tenants residing in the property may be generated based on the received sensor data and/or aggregated/averaged sensor data. Insights about the property and/or tenants residing in the property may be used to determine whether a particular property is suitable for a potential tenant. For example, insights may include information about space, noise, temperature, and/or crowdedness.

Generating insights related to space, noise, temperature, crowdedness, etc. may include generating a score for each insight. For example, the server 110 may analyze the sensor data for a property, along with the one or more attributes for the property and the one or more attributes of the one or more tenants residing in the property, to generate one or more insights. Further, insights may be generated after a predetermined time has elapsed. For example, insight may be generated after 1 month, 2 months . . . 11 months, 1 year, etc. This delayed generation may allow for the one or more sensors in and/or on the property to provide enough sensor data.

To determine whether space is sufficient, average closet usage (with breakdown for bedrooms, kitchen/pantry, living areas, etc.) may be determined based on sensor data from one or more sensors 108. Other areas of the property, such as an attic and/or a garage, may be designated as long-term-storage space, and sensor data from sensors 108 may be used to determine whether space is sufficient. Accordingly, based on the sensor data from the one or more sensors a space score may be generated. The space score may be indicative of whether a particular tenant requires a large amount of space and/or indicative of the free space available in a particular property.

A noise score for internal and/or external noise in the morning, afternoon, evening, nighttime, etc. may be generated based on sensor data from certain sensors 108 located inside and outside of a property 104a. For example, sensors located outside of the property may be used to generate an exterior noise score. Alternatively, certain sensors 108 located within the property may be used to measure noise within the property when the tenants are either asleep or not present, and may be used to generate an external noise score. Internal noise caused by the tenants (e.g., in a given room and of a given type) may also be measured and used to generate an internal noise score. In certain embodiments of the present disclosure, the noise score may be a number of minutes in a predetermined time period when a noise exceeds a predetermined threshold. In one embodiment, one predetermined threshold may be relatively low for predetermined time periods, such as when tenants are likely to be sleeping. Another predetermined threshold may be relatively high for other predetermined time periods, such as when tenants are likely to be awake. For example, a dog barking loudly and waking people up at night may take just minutes each time to be considered disruptive, while a dog barking loudly when an unwelcome visitor comes to the property may be considered helpful. Further, the internal noise score that is generated for given tenants and/or properties may be adjusted based on one or more attributes of the particular tenants residing at the property and/or one or more attributes of the property. For example, the internal noise score may be adjusted down or up depending on a size of the property, a type of property, a number of tenants, a quality of sound insulation within the property, and/or other attributes of the tenants.

A cleanliness score may be generated based on sensor data from certain sensors 108 located inside of the property. For example, the cleanliness score may be generated based on sensors used to determine by how often a cleaning closet is opened, how often a vacuum cleaner is used, how often kitchen trash is removed, etc. Further, air quality sensors may measure presence of dust particles, and used to generate the cleanliness score. Additionally, a number of times a camera detects whether a given worktop or floor space has objects (i.e., clutter) removed may also be used to generate the cleanliness score.

A comfort score may be generated based on sensor data from certain sensors 108 located inside and outside of the property. To determine a comfort score, an average temperature and humidity from the sensors of the property (when tenants may be away, present, and/or are sleeping) may be calculated. In certain embodiments of the present disclosure, the score may be computed based on a derivation from 70 degrees F. and less than or equal to 20% humidity. Additionally, an average daily cost of achieving the comfort score may be calculated. For example, the average daily cost may be computed by considering all days when the weather was cold/hot and/or humid and counting an average cost of running heating and/or air condition systems.

A suitability score for one or more rooms in the property, the property, and/or a tenant of the property may be generated based on sensor data from certain sensors 108 located inside of the property. For example, a suitability score for kitchen suitability may be computed by determining when mealtimes are detected (such as when ranges, ovens, microwaves, and/or refrigerators are used), and determining how much of each appliance is used, the percentage of space in the refrigerator, the detected space available on the worktops (e.g., to the nearest square foot), a number of people eating (compared to available spaces at the kitchen table or dining table), etc. In one embodiment of the present disclosure, an individual score may be determined for each factor, and the individual scores may be assigned a weight before combined (e.g., by summing the weighted individual scores) to generate a suitability score for each room. The weights for the individual scores may be derived by training, e.g., comparing tenant surveys against the sensor data (including tenant profile, e.g. single/married/has kids) to derive optimal weights for each individual score given a type of property or a geographic region.

Further, a suitability score for a tenant and/or a property may be used to determine whether one or more tenants of the property are unsuitable to continue renting the property. For example, one or more sensors in and/or on the property may monitor parking spaces, read license plates of vehicles, and/or detecting if a tenant's cars may be parking in a neighbor's parking space. Additionally, if one or more unknown vehicles may be parking on a regular basis, such as hourly, daily, weekly, or monthly, in a driveway of the property, or if a tenant is visited by a large number of different people every day as detected through facial recognition, the sensor data may be used to determine that a tenant may be operating an unlicensed business on the property. Further, one or more sensors may monitor power consumption, and may be used to determine whether excessive power is being used by a tenant. These one or more sensors may be used to determine a possibility of growing and/or production of illicit drugs and/or materials, which may be used to determine a tenant's suitability score. In another example embodiment, one or more sensors may detect frequent barking and/or meowing within a property that does not allowed pet, and thus, a tenant's suitability score may be lower. Additionally, one or more sensors that detect window breakage, stove breakage, fridge breakage may be used to determine a property's suitability score.

In one embodiment of the present disclosure, commercial properties may have scores generated based on sensor data from certain sensors 108 located inside and outside of the property. For example, scores may be generated for a warehouse space, cash register speed, etc.

Once insights have been generated, one or more portals may be generated that provide the insights, a list of potential tenants, available properties, etc. In one embodiment of the present disclosure, server 110 may generate a landlord portal. The landlord portal may include a plurality of views. For example, a landlord portal view may include a list of properties of the landlord/property owner, a time remaining on a lease for each property of the landlord/property owner, a tenant score for each tenant of a property of the landlord/property owner, a tenant satisfaction score for each tenant of a property of the landlord/property owner. A tenant score may be one or more scores derived and/or generated from one or more of the above-described scores. For example, a tenant score may be generated based on one or more suitability scored for one or more rooms, a cleanliness score, a noise score, etc. The tenant score may also be generated based on one or more variables from other systems, such as an initial credit score when a tenant first rents a property, an updated credit score after a predetermined amount of time, proof of employment, records of complaints, and/or a tenant's feedback. In certain embodiments of the present disclosure, the tenant score may be weighted. For example, the tenant score may be a combination of a worst score, an average score, and/or a best score. The tenant score may allow a landlord/property owner of the property rented by the tenant to decide whether rental of the property should be renewed with the tenant. Further, a landlord/property owner may view a tenant score and/or a profile of potential new tenants.

In another embodiment of the present disclosure, a landlord portal view may include a list of one or more issues with each property. For example, a list of one or more issues may include external noise, temperature/humidity comfort, kitchen/living area suitability, easy-access, long-term storage, etc. The list of one or more issues may be viewed across a plurality of properties of the landlord/property owner, and the list or one or more issues may inform the landlord/property owner whether an investment should be made in additional/better facilities to improve tenant retention. The landlord portal views may provide valuable insights because tenants may not provide adequate information to allow an informed decision by the landlord/property owner. For example, a tenant to ensure that he or she gets a good reference from the landlord may simply politely vacate the property and rent another property rather than say what may be wrong with the original property.

In one embodiment of the present disclosure, server 110 may generate a tenant portal. The tenant portal may include a plurality of views. For example, a tenant portal view may include a plurality of different properties available to rent and/or buy, a suitability score, available space, comfort levels, etc. The tenant portal view may allow for potential tenants to be informed of kitchen space, living space, storage space, heating and/or air condition ratings, energy ratings, etc. of potential properties to rent. For example, if a tenant has an 80 square foot kitchen and sensor data indicates that the kitchen is below a predetermined size threshold, a minimum desired kitchen space may be increased, such as to 120 square feet. As mentioned above, one or more sensors may be used to determine that utilization of various spaces, such as kitchen space, cabinet space, etc., is above a predetermined size threshold, such as 98%. The predetermined size threshold may be a fixed percentage, for example, 95% utilization, and/or may be based on a comparison of the current tenant's space score to one or more other tenants' space scores in other properties, such as tenants in similar properties or similar tenants.

A list of desired parameters of a tenant may be used when accessing the property database. Each property of available properties may then be ranked according to a degree to which meet requirements of the tenant. Further, the tenant portal view may provide visual indications that show that a given property may be deficient in one or more respects. In certain embodiments of the present disclosure, current tenants of a property available for rent may provide a property rating that a potential tenant may view. For example, current tenants may provide one or more of their above-mentioned score, such as an average comfort of the tenants, an average external noise, available storage, etc.

In other embodiments of the present disclosure depending on privacy policies set up by one or both of the landlord/property owner and/or one or more tenants, the above-mentioned insights may be provided to advertisers. For example, if a current tenant requires more space in a property, this information may be provided to an Internet advertiser, which may then provide advertisements to the tenant of suitable rental properties and/or other alternate solutions.

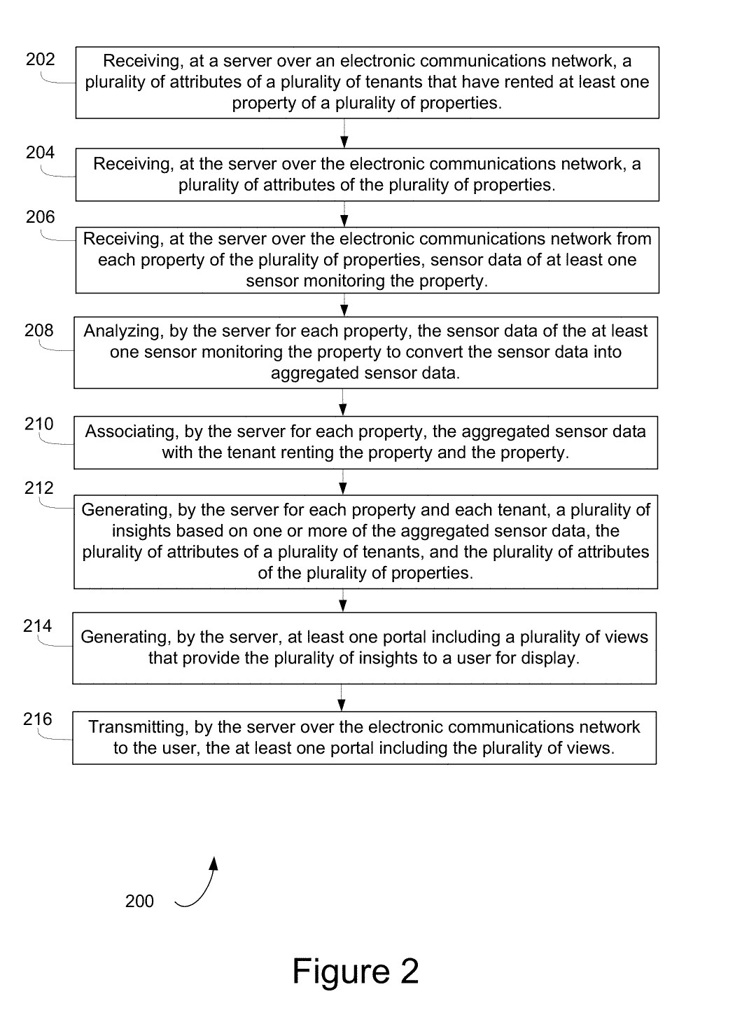

FIG. 2 depicts a flowchart illustrating a method 200 for generating property and tenant insights based on sensor devices, according to embodiments of the present disclosure. The method 200 for generating property and tenant insights based on sensor devices may begin at step 202 in which a server may receive, over an electronic communications network, a plurality of attributes of a plurality of tenants that have rented at least one property of a plurality of properties. Then, at step 204, the server may receive, over the electronic communications network, a plurality of attributes of the plurality of properties.

The server may then receive, at step 206, over the electronic communications network from each property of the plurality of properties, sensor data of at least one sensor monitoring the property. After receiving the sensor data of the at least one sensor monitoring the property, the server, for each property, may analyze the sensor data of the at least one sensor monitoring the property to convert the sensor data into aggregated sensor data at step 208.

Once the sensor data is analyzed, the server, at step 210 may associate the aggregated sensor data with the tenant renting the property and the property. Then at step 212, the server may generate, for each property and each tenant, a plurality of insights based on one or more of the aggregated sensor data, the plurality of attributes of a plurality of tenants, and the plurality of attributes of the plurality of properties.

At step 214, the server may generate at least one portal including a plurality of views that provide the plurality of insights to a user for display, and at step 216, the server may transmit, over the electronic communications network to the user, the at least one portal including the plurality of views.

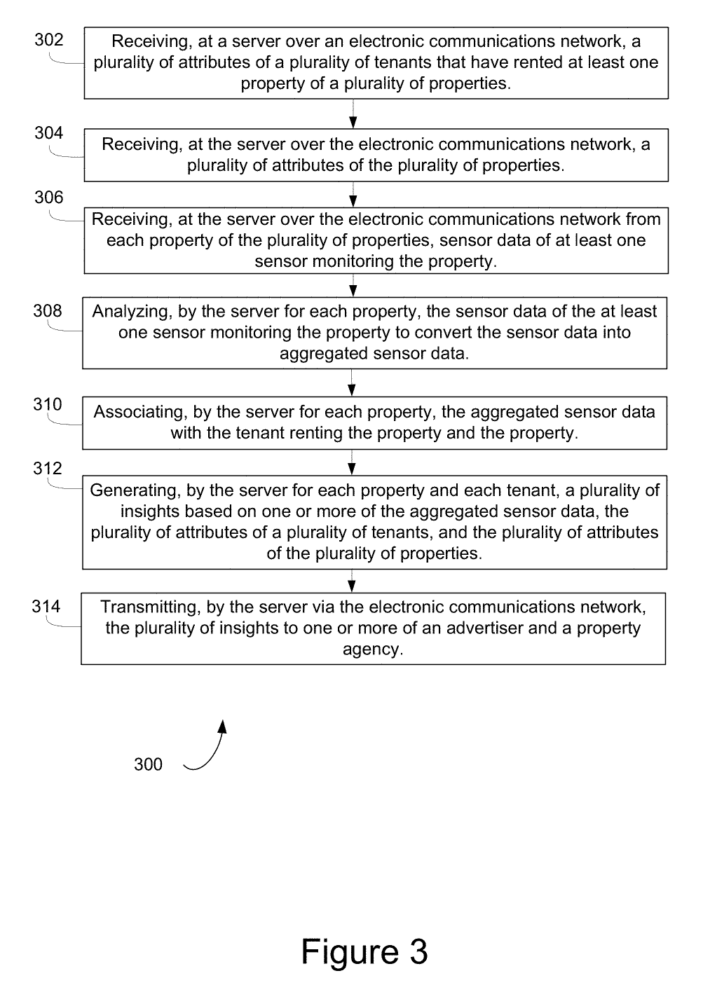

FIG. 3 depicts another flowchart illustrating a method 300 for generating property and tenant insights based on sensor devices, according to embodiments of the present disclosure. The method 300 for generating property and tenant insights based on sensor devices may begin at step 302 in which a server may receive, over an electronic communications network, a plurality of attributes of a plurality of tenants that have rented at least one property of a plurality of properties. Then, at step 304, the server may receive, over the electronic communications network, a plurality of attributes of the plurality of properties.

The server may then receive, at step 306, over the electronic communications network from each property of the plurality of properties, sensor data of at least one sensor monitoring the property. After receiving the sensor data of the at least one sensor monitoring the property, the server, for each property, may analyze the sensor data of the at least one sensor monitoring the property to convert the sensor data into aggregated sensor data at step 308.

Once the sensor data is analyzed, the server, at step 310 may associate the aggregated sensor data with the tenant renting the property and the property. Then at step 312, the server may generate, for each property and each tenant, a plurality of insights based on one or more of the aggregated sensor data, the plurality of attributes of a plurality of tenants, and the plurality of attributes of the plurality of properties. At step 314, the server may transmit via the electronic communications network, the plurality of insights to one or more of an advertiser and a property agency.

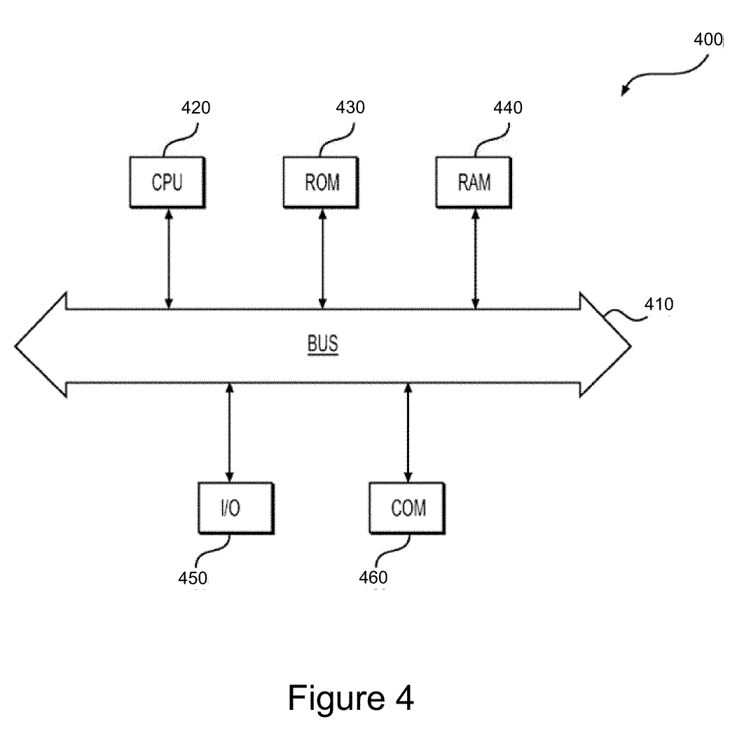

FIG. 4 is a simplified functional block diagram of a computer that may be configured as devices, systems, and/or servers for executing the methods of FIGS. 2 and 3, according to exemplary an embodiment of the present disclosure. Specifically, in one embodiment, any of the devices, systems, and/or servers may be an assembly of hardware 400 including, for example, a data communication interface 460 for packet data communication. The platform may also include a central processing unit (“CPU”) 420, in the form of one or more processors, for executing program instructions. The platform includes an internal communication bus 310, program storage, and data storage for various data files to be processed and/or communicated by the platform, such as ROM 430 and RAM 440, although the system 400 receives programming and data via network communications 460. The server 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical and line networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data within an Internet environment, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

Other embodiments of the disclosure will be apparent to those skilled in the art from consideration of the specification and practice of the disclosure provided herein. It is intended that the specification and examples be considered as exemplary only, with a true scope and spirit of the present disclosure being indicated by the following claims.

What is claimed is:

1. A computer-implemented method for generating property and tenant insights based on sensor devices, the method comprising:
receiving, at a server over an electronic communications network, a plurality of attributes of a plurality of tenants that have rented at least one property of a plurality of properties;
receiving, at the server over the electronic communications network, a plurality of attributes of the plurality of properties;
receiving, at the server over the electronic communications network from each property of the plurality of properties, sensor data of at least one sensor monitoring the property;
analyzing, by the server for each property, the sensor data of the at least one sensor monitoring the property to convert the sensor data into aggregated sensor data;
associating, by the server for each property, the aggregated sensor data with the tenant renting the property and the property; and
generating, by the server for each property and each tenant, a plurality of insights based on one or more of the aggregated sensor data, the plurality of attributes of a plurality of tenants, and the plurality of attributes of the plurality of properties.

2. The method of claim 1, further comprising:
generating, by the server, at least one portal including a plurality of views that provide the plurality of insights to a user for display; and
transmitting, by the server over the electronic communications network to the user, the at least one portal including the plurality of views.

3. The method of claim 2, wherein the at least one portal includes one or more of a tenant portal including a plurality of tenant portal views and a landlord portal including a plurality of landlord portal views.

4. The method of claim 1, wherein analyzing the sensor data of the at least one sensor monitoring the property to convert the sensor data into aggregated sensor data includes:
generating, by the server for each property, a space score based on the aggregated sensor data from the at least one sensor monitoring the property.

5. The method of claim 1, wherein analyzing the sensor data of the at least one sensor monitoring the property to convert the sensor data into aggregated sensor data includes:
generating, by the server for each property, a suitability score based on the aggregated sensor data from the at least one sensor monitoring the property.

6. The method of claim 5, wherein generating the suitability score is based on the aggregated sensor data from the at least one sensor monitoring the property and data not from the at least one sensor.

7. The method of claim 6, wherein the data not from the at least one sensor is one or more of an initial credit score when the tenant first rents the property, an updated credit score after a predetermined amount of time, proof of employment, records of complaints, and feedback of the tenant.

8. The method of claim 5, wherein analyzing the sensor data of the at least one sensor monitoring the property to convert the sensor data into aggregated sensor data includes:
generating, by the server for each property, one or both of an internal noise score and an external noise score based on the aggregated sensor data from the at least one sensor monitoring the property, and
wherein generating the suitability score is based on the aggregated sensor data from the at least one sensor monitoring the property and the one or both of the internal noise score and the external noise score.

9. The method of claim 8, wherein the one or both of the internal noise score and the external noise score is generating based on a number of minutes in a predetermined time period when a noise exceeds a predetermined threshold.

10. The method of claim 5, wherein the at least one sensor monitoring the property includes one or more sensors monitoring one or more of a parking space of the property and a license plate of a vehicle in the parking space, and
wherein generating the suitability score is based on the aggregated sensor data from the at least one sensor monitoring the property and the one or more sensors monitoring one or more of the parking space of the property and a license plate of a vehicle in the parking space.

11. The method of claim 1, wherein analyzing the sensor data of the at least one sensor monitoring the property to convert the sensor data into aggregated sensor data includes:
generating, by the server for each property, a comfort score based on the aggregated sensor data from the at least one sensor monitoring the property, and
wherein generating the suitability score is based on the aggregated sensor data from the at least one sensor monitoring the property and the comfort score.

12. The method of claim 1, wherein analyzing the sensor data of the at least one sensor monitoring the property to convert the sensor data into aggregated sensor data includes:
generating, by the server for each property, a score for a commercial property based on the aggregated sensor data from the at least one sensor monitoring the property and based on one or more of storage space, shelf space, a number of cash registers, a size of windows, type of property, warehouse space, a length of a line at the cash registers, a number of meeting rooms available, and a number of people sitting in a meeting room.

13. A system for generating property and tenant insights based on sensor devices, the system including:
a data storage device that stores instructions for generating property and tenant insights based on sensor devices; and
a processor configured to execute the instructions to perform a method including:
receiving, over an electronic communications network, a plurality of attributes of a plurality of tenants that have rented at least one property of a plurality of properties;
receiving, over the electronic communications network, a plurality of attributes of the plurality of properties;
receiving, over the electronic communications network from each property of the plurality of properties, sensor data of at least one sensor monitoring the property;
analyzing, for each property, the sensor data of the at least one sensor monitoring the property to convert the sensor data into aggregated sensor data;
associating, for each property, the aggregated sensor data with the tenant renting the property and the property; and
generating, for each property and each tenant, a plurality of insights based on one or more of the aggregated sensor data, the plurality of attributes of a plurality of tenants, and the plurality of attributes of the plurality of properties.

14. The system of claim 13, wherein the processor is further configured to execute the instructions to perform the method including:
generating at least one portal including a plurality of views that provide the plurality of insights to a user for display; and
transmitting, over the electronic communications network to the user, the at least one portal including the plurality of views.

15. The system of claim 14, wherein the at least one portal includes one or more of a tenant portal including a plurality of tenant portal views and a landlord portal including a plurality of landlord portal views.

16. The system of claim 13, wherein analyzing the sensor data of the at least one sensor monitoring the property to convert the sensor data into aggregated sensor data includes:
generating, for each property, a suitability score based on the aggregated sensor data from the at least one sensor monitoring the property.

17. The system of claim 16, wherein generating the suitability score is based on the aggregated sensor data from the at least one sensor monitoring the property and data not from the at least one sensor.

18. The system of claim 17, wherein the data not from the at least one sensor is one or more of an initial credit score when the tenant first rents the property, an updated credit score after a predetermined amount of time, proof of employment, records of complaints, and feedback of the tenant.

19. A non-transitory computer-readable medium storing instructions that, when executed by a computer, cause the computer to perform a method for generating property and tenant insights based on sensor devices, the method including:
receiving, over an electronic communications network, a plurality of attributes of a plurality of tenants that have rented at least one property of a plurality of properties;
receiving, over the electronic communications network, a plurality of attributes of the plurality of properties;
receiving, over the electronic communications network from each property of the plurality of properties, sensor data of at least one sensor monitoring the property;
analyzing, for each property, the sensor data of the at least one sensor monitoring the property to convert the sensor data into aggregated sensor data;
associating, for each property, the aggregated sensor data with the tenant renting the property and the property; and
generating, for each property and each tenant, a plurality of insights based on one or more of the aggregated sensor data, the plurality of attributes of a plurality of tenants, and the plurality of attributes of the plurality of properties.

20. The computer-readable medium of claim 19, further comprising:
generating at least one portal including a plurality of views that provide the plurality of insights to a user for display; and
transmitting, over the electronic communications network to the user, the at least one portal including the plurality of views.
